(19) United States
(12) Patent Application Publication
(10) Pub. No.: US 2023/0084911 A1
(43) Pub. Date: Mar. 16, 2023

(54) Time-Domain Positions of Synchronization Signals

(71) Applicant: Nokia Technologies Oy, Espoo (FI)

(72) Inventors: Sami Hakola, Kempele (FI); Esa TIIROLA, Kempele (FI); Jorma KAIKKONEN, Oulu (FI)

(21) Appl. No.: 17/799,110

(22) PCT Filed: Feb. 14, 2020
(86) PCT No.: PCT/EP2020/053957

§ 371 Date: Aug. 11, 2022

(51) Int. Cl. H04W 56/00

(52) U.S. Cl. CPC H04W 56/0005

(57) ABSTRACT

Synchronization signal numerology of a communications system is determined, on the basis of at least two reference numerologies. Time occasions comprising including synchronization signals are determined on the basis of a first reference numerology of the at least two reference numerologies for synchronization signal numerologies. Positions of the synchronization signals within the determined time occasions are determined on the basis of a second reference numerology of the at least two reference numerologies. Positions of the synchronization signals according to the synchronization signal numerology are determined at least on the basis of the determined time occasions and the positions within the time occasions. The synchronization signals are received at the determined positions. In this way, the synchronization signal block duration may be extended in time and/or the number of synchronization signal blocks may be increased without introducing a need for a new numerology for synchronization signal numerologies.

### TECHNICAL FIELD

The present invention relates to determining time-domain positions of synchronization signals.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Synchronization signals are used in communications systems for enabling user equipment (UE) to find, measure and access to cells. If a carrier frequency of a communications system is increased, propagation loss increases with the increasing carrier frequency. Therefore, coverage of the synchronization signals is likely to suffer.

Positions of synchronization signals are needed to perform cell search and mobility measurement procedures. Subcarrier spacing is a parameter related to a numerology. The subcarrier spacing of a synchronization signal block (SSB) impacts to the positions of the SSBs and for measurement timing configurations.

Positions for the synchronization signals are defined only for the existing numerologies that are up-to 240 kHz subcarrier spacing, and for up-to 64 SSB beams. Defining a new numerology for synchronization signals would require defining the new positions. The same holds for if the number SSB beams would be increased from 64. These enhancements could introduce a problem with backward compatibility.

### SUMMARY

The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According some aspects, there is provided the subject matter of the independent claims. Some further aspects are defined in the dependent claims. The embodiments that do not fall under the scope of the claims are to be interpreted as examples useful for understanding the disclosure.

### BRIEF DESCRIPTION OF THE DRAWINGS

For a more complete understanding of example embodiments of the present invention, reference is now made to the following descriptions taken in connection with the accompanying drawings in which:

FIG. 1 shows a part of an exemplifying wireless communications access network in accordance with at least some embodiments of the present invention;

FIGS. 2 and 3 illustrate examples of methods in accordance with at least some embodiments of the present invention;

FIGS. 4 to 6 illustrate examples of determining positions of synchronization signals in accordance with at least some embodiments of the present invention;

FIG. 7 illustrates an apparatus in accordance with at least some embodiments of the present invention.

### DETAILED DESCRIPTION OF SOME EXAMPLE EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

In connection with synchronization signals fora communications system, there is provided determining a synchronization signal numerology of the communications system, on the basis of at least two reference numerologies. Time occasions comprising synchronization signals are determined on the basis of a first reference numerology of the at least two reference numerologies for synchronization signal numerologies. Positions of the synchronization signals within the determined time occasions are determined on the basis of a second reference numerology of the at least two reference numerologies. Time-domain positions of the synchronization signals according to the synchronization signal numerology are determined at least on the basis of the determined time occasions and the positions within the time occasions. The synchronization signals are received at the determined time-domain positions. In this way, the synchronization signal (block) duration may be extended in time and/or the number of synchronization signals may be increased without introducing a need for a new numerology for synchronization signal numerologies. Extending the duration of the SSB block in time, provides extended coverage for the signals in the SSB block. The increased number of synchronization signal blocks provide that a number of beams may be increased for transmitting the signals in the SSB block. Particularly, for the 5G radio access technology, i.e. New Radio (NR), based system operating at above 52.6 GHz, there is provided that existing functionality for FR2, i.e. frequencies 24-52.6 GHz, may be reused if a comparable coverage with NR operating at FR2 (24-52.6 GHz) can be supported.

Extending duration of the synchronization signal or SSB blocks may refer to adding more symbols to the SSB block, e.g. having 4 symbols for primary synchronization signals, 4 symbols for secondary synchronization signals and 8 symbols for PBCH, as an example of 4 times longer duration in terms of number of symbols in SSB block which has now 1 symbol for primary synchronization signal, 1 symbols for secondary synchronization signal and 2 symbols for PBCH.

Time occasion may refer to an element in a frame structure of a communications system. The element may be time slot, a symbol, a set of time slots or a set of symbols. Examples of the symbols comprise OFDM symbols. An example of the frame structure is a frame structure for 5G NR, where a frame has duration of 10 ms which consists of 10 subframes having 1 ms duration each. Each subframe may have 2^{μ} time slots, where p is a positive integer according to a transmission numerology. Each time slot may consist of 14 OFDM symbols.

Present New Radio (NR) Release 15 WI specifications define operation for frequencies up to 52.6 GHz. Frequency allocations beyond 52.6 GHz contain very large spectrum allocations and will support many high capacity use cases such as integrated access and backhaul (IAB), broadband distribution network, factory automation and high data rate enhanced Mobile Broadband (eMBB). Coverage extension for Synchronization Signal Block (SSB) transmissions on frequencies above 52.6 GHz should be supported in order to have a comparable coverage with NR operating at FR2, i.e. at frequencies 24-52.6 GHz, and easy deployment by reusing the same sites/antenna locations for the base stations (gNBs) as used for the system at below 52.6 GHz.

In Release 15 (Rel15) of the 3GPP specifications, in the frequency range between 24 and 52.6 GHz (FR2) there can be up to 64 SSBs, or beams, within a 5 ms half-frame in fixed specified positions in the time slots. NR Rel15 supports up to 4 SSB positions, i.e. 4 SSB beams, at frequencies below 3 GHz; up to 8 SSB positions in the frequency range between 3 and 6 GHz; and up to 64 SSB positions in frequency range between 24 and 52.6 GHz. The SSB duration is 4 symbols and the SSB comprises primary synchronization signal (PSS), secondary synchronization signal (SSS) and physical broadcast channel (PBCH) with accompanied demodulation reference signal (DMRS). An example of the SSB structure is provided in Section 5.2.4 of TS 38.300 version 16.0.0. However, going beyond 52.6 GHz, a higher number than 64 SSB beams should be enabled in order to support a reasonable cell radius, e.g. the same as for below 52.6 GHz, where frequency dependent path loss difference is expected to be compensated by additional antenna/beamforming gain. More particularly, when going higher in carrier frequency due to physical limitations of the transistors output power per Power Amplifier (PA) decreases as a function of carrier frequency. Furthermore, at least when existing waveforms (i.e. OFDM for Downlink) frequencies below 52.6 GHz are used, the PA needs to be operated with relatively high back-off values, which requires more beamforming gain. At the same time, propagation loss increases with the increasing carrier frequency. In order to reach the same Effective Radiated Power (EIRP) as in lower carrier frequencies, i.e. below 52.6 GHz, the higher carrier frequency antenna needs to provide higher antenna/beamforming gain. Higher antenna/beamforming gain turns into more narrow beam widths in use for the signal transmission and reception. Regarding SSB transmission it means that a cell should have a possibility to an increased number of SSB beams, i.e. basically an increased number of SSB positions. Moreover, it may be preferred that implementations of products can reuse existing implementations for frequencies below 52.6 GHz and that changes to the specifications may be preferred to be small. Therefore, the number of SSB beams should be increased preferably with low specification impact.

A synchronization signal numerology, or also referred to herein as a target numerology, of communications system may refer to one or more properties for configuring a transmission of a synchronization signal by a radio device of the communications system. In an example the synchronization signal may be an SSB. Examples of the properties comprise at least a time slot length, an Orthogonal Frequency Division Multiplexing (OFDM) symbol length, a Cyclic Prefix (CP) length, a start position of synchronization signal within a time slot and end position of synchronization signal within a time slot. Examples of numerologies comprise numerologies that utilize time-frequency scaling. The time-frequency scaling may be characterized by a scaling factor 2^{μ}. The scaling decreases the time domain properties such as a time slot length, OFDM symbol length, CP length by factor of 2^{μ}, and increases the frequency domain properties such as subcarrier spacing and Physical Resource Block (PRB) size in frequency by factor of 2^{μ}. Examples of the numerologies defined are provided in Table 4.2-1 of TS 38.211 “Physical channels and modulation”, V15.8.0 (2019-12) of the Release 15 specifications:

TABLE 4.2-1
Supported transmission numerologies.

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

In table 4.2-1 Δf=2^{μ}·15 [kHz] defines a subcarrier spacing. It should be noted that there is a difficulty in introducing new numerologies with a higher subcarrier spacings than in Table 4.2-1, since a higher subcarrier spacing could lead to at least one or more of:
larger carrier bandwidth for a given Fast Fourier Transform (FFT) size, e.g. 4k FFT,
smaller symbol duration and potentially lower latency,
smaller channel access overhead due to finer-granularity frame design,
reduced sensitivity to phase noise, and
reduced Cyclic Prefix (CP) length (for a given CP overhead).

A synchronization signal may be at least used for configuration of measurements performed by UE. The measurements provide for finding and accessing to cells of a communications system. The measurements may be performed in accordance with a measurement timing configuration. In the context of New Radio (NR), the synchronization signal may be referred to a Synchronization Signal Block (SSB). In NR, the Synchronization Signal Block (SSB) forms a basis for the UE to find, measure and access to an NR cell. The SSB comprises primary and secondary synchronization signals as well as physical broadcast channel to carry essential system information parameters. The parameters include information how and when to monitor Type0-Physical Dedicated Control Channel (Type0-PDCCH) for scheduling Physical Dedicated Shared Channel (PDSCH) that carries the remaining minimum system information (a.k.a. SIB-1) needed by a UE to be able to access to a cell. An example of a measurement timing configuration is an SSB-based measurement timing configuration (SMTC) configured by SSB-MeasurementTimingConfiguration as specified in 3GPP TS 38.331: “NR; Radio Resource Control (RRC); Protocol specification”, version 15.8.0. It should be appreciated that a synchronization signal may refer to the SSB according of the Release 15 specifications, i.e. comprising PSS, SSS, PBCH+DRMS. It may cover also scenarios where “synchronization signals” correspond to another signal combination to construct “SSB”, e.g. current SSB+CSI-RS. On the other hand, it may cover scenarios with only one signal, such as PSS only, or PSS+SSS.

A radio device may be a device configured for communications on radio waves over a wireless radio link, i.e. a wireless link. The communications may comprise user traffic and/or signaling. The user traffic may comprise data, voice, video and/or audio. Examples of the wireless link comprise a point-to-point wireless link and a point-to-multipoint wireless link. The wireless link may be provided between two radio devices. It should be appreciated that the radio devices may have differences. For example, radio devices connected by a wireless link may comprise one or more of a user equipment (UE), an access node, an access point, a relay node, a user terminal and an Internet of Things (IoT) device.

A radio device may be a radio access device that is configured to serve a plurality of other radio devices, user radio devices, and give radio access to a communications system for the user radio devices. A radio device may also be a radio station serving as relay node or providing a wireless backhaul for one or more radio access nodes. Examples of the radio access devices comprise at least an access node, an access point, a base station and an (e/g)NodeB. Another example covering the relay node deployment is a Distributed Unit (DU) Distributed Unit part of an Integrated Backhaul and Access (IAB) node. Examples of the user radio devices comprise at least a user terminal and user equipment (UE). Another example covering the relay node deployment is a Mobile Termination (MT) part of an IAB node. The radio device may be an aerial radio device and/or an extraterrestrial radio device configured to operate above the ground without a fixed installation to a specific altitude. Examples of extra-terrestrial radio devices comprise at least satellites and spacecraft that are configured for radio communications in a communications system that may comprise both terrestrial and extraterrestrial radio devices. Examples of aerial radio devices comprise at least High Altitude Platform Stations (HAPSs) and unmanned aerial vehicles (UAVs), such as drones. The radio access device may have one or more cells which the user radio devices may connect to in order to access the services of the communications system via the radio access device. The cells may comprise different sizes of cells, for example macro cells, micro cells, pica cells and femto cells. A macro cell may be a cell that is configured to provide coverage over a large coverage area in a service area of the communications system, for example in rural areas or along highways. A micro cell may be a cell that is configured to provide coverage over a smaller coverage area than the macro cell, for example in a densely populated urban area. Pico cells may be cells that are configured to provide coverage over a smaller area than the micro cells, for example in a large office, a mall or a train station. Femto cells may be cells that are configured to provide coverage over a smaller area than the femto cells, for example at homes or small offices. For example macro cells provide coverage for user radio devices passing a city on a motorway/highway and local cells, e.g. micro cells or smaller cells, provide coverage for user radio devices within the city. In another example, macro cells provide coverage for aerial radio devices and/or extraterrestrial radio devices and local cells, e.g. micro cells or smaller cells, provide coverage for the aerial radio devices and/or extraterrestrial radio devices that are located at elevated positions with respect to one or more radio access devices of the communications system. Accordingly, an aerial radio device or extraterrestrial radio device may be connected to a micro cell of a radio access device and when the aerial radio device or extraterrestrial radio device is above a certain height from the ground, the aerial radio device or extraterrestrial radio device may be switched to a macro cell, for example by a handover procedure.

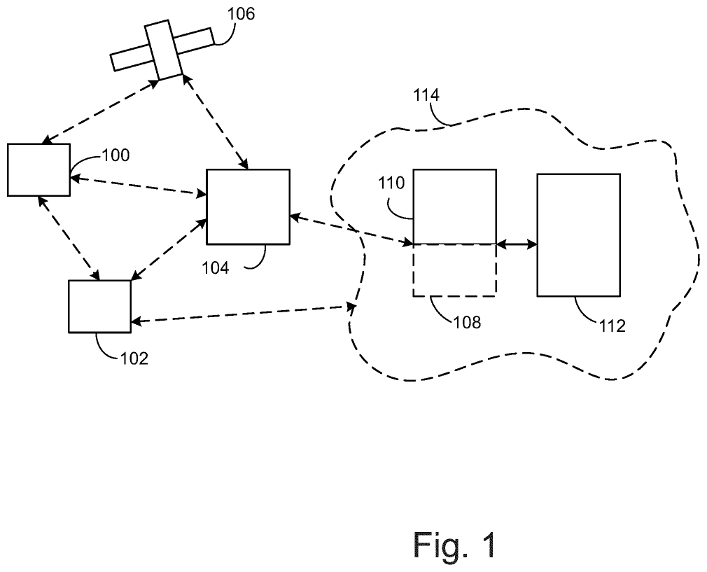

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage. The access node provides access by way of communications of radio frequency (RF) signals and may be referred to a radio access node. It should be appreciated that the radio access network may comprise more than one access nodes, whereby a handover of a wireless connection of the user device from one cell of one access node, e.g. a source cell of a source access node, to another cell of another node, e.g. a target cell of a target access node, may be performed.

A communication system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, wireless device, communications device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay), e.g. a DU part of an IAB node, towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation is carried out in the cloud. The user device (or in some embodiments a layer 3 relay node, e.g. an MT part of an IAB node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or NodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)NodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)NodeBs), a home node B gateway, or HNB-GW (not shown in FIG. 1). A HNB Gateway (HNB-GW), which is typically installed within an operator's network may aggregate traffic from a large number of HNBs back to a core network.

The embodiments are not, however, restricted to the system given as an example but a person skilled in the art may apply the solution to other communication systems provided with necessary properties.

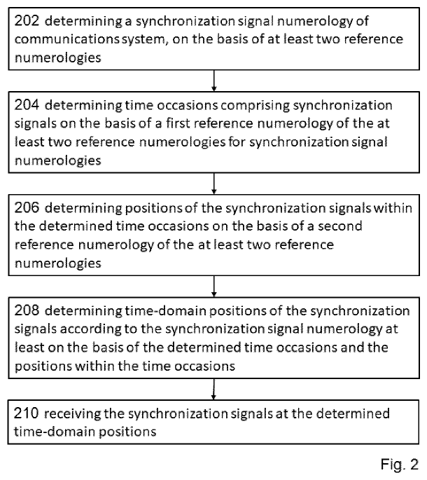

Referring to FIG. 2, there is provided an example of a method for supporting coverage extension of synchronization signals. In an example the method may be performed at a user radio device, for example UE.

Phase 202 comprises determining a synchronization signal numerology of communications system, on the basis of at least two reference numerologies.

Phase 204 comprises determining time slots comprising synchronization signals on the basis of a first reference numerology of the at least two reference numerologies for synchronization signal numerologies.

Phase 206 comprises determining positions of the synchronization signals within the determined time slots on the basis of a second reference numerology of the at least two reference numerologies.

Phase 208 comprises determining time-domain positions of the synchronization signals according to the synchronization signal numerology at least on the basis of the determined time slots and the positions within the time slots.

Phase 210 comprises receiving the synchronization signals at the determined time-domain positions.

In an example in accordance with at least some embodiments, phase 210 comprises receiving an indication of a part of a synchronization signal block index via a physical broadcast channel of the synchronization signal block. The indication of a synchronization signal index provides determining the synchronization signal numerology for more than one beam.

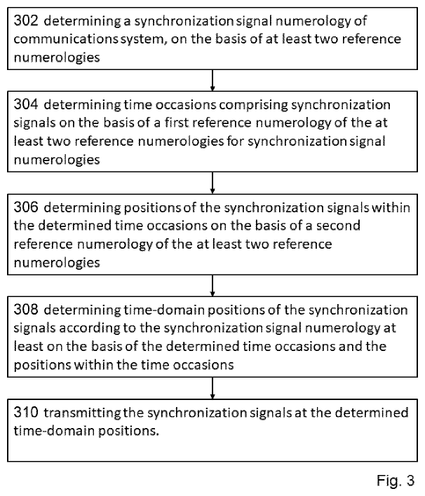

Referring to FIG. 3, there is provided an example of a method for supporting coverage extension of synchronization signals. In an example the method may be performed by at radio access device, for example a gNB.

Phase 302 comprises determining a synchronization signal numerology of communications system, on the basis of at least two reference numerologies.

Phase 304 comprises determining time slots comprising synchronization signals on the basis of a first reference numerology of the at least two reference numerologies for synchronization signal numerologies.

Phase 306 comprises determining positions of the synchronization signals within the determined time slots on the basis of a second reference numerology of the at least two reference numerologies.

Phase 308 comprises determining time-domain positions of the synchronization signals according to the synchronization signal numerology at least on the basis of the determined time slots and the positions within the time slots.

In an example, phase 202 and phase 302 comprise that the synchronization signal numerology supports more than 64 positions of the synchronization signal in a frame structure of the communications system. In an example, a synchronization signal index included in a PBCH may be used to extend the number of positions above 64.

Phase 310 comprises transmitting the synchronization signals at the determined time-domain positions.

In an example, phase 202 and phase 302 comprise that at least one property of the synchronization signal numerology is inherited from the reference numerologies. The inherited properties may comprise at least a time slot length, an Orthogonal Frequency Division Multiplexing (OFDM) symbol length, a Cyclic Prefix (CP) length, a start position of synchronization signal within a time slot and end position of synchronization signal within a time slot.

In an example in accordance with at least some embodiments, phase 206 and 306 comprise determining starting positions for synchronization signals according to the synchronization signal numerology to be the same with starting positions according to the second reference numerology.

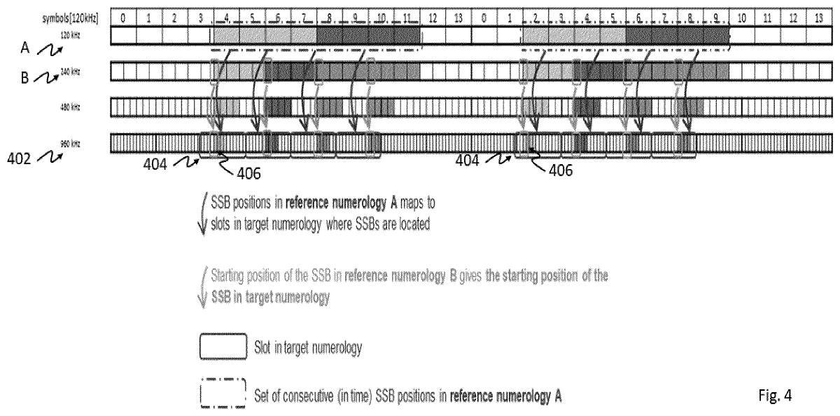

In an example in accordance with at least some embodiments, phase 206 and 306 comprise determining a duration, in absolute time or in a number of symbols, of the synchronization signal to be the same as for synchronization signals in accordance with the second reference numerology. The durations are described in FIGS. 4 to 6 below, where Option 1 and Option 3 describe the same duration with the reference numerology in symbols and option 2 describes the same duration with the reference numerology in time.

In an example in accordance with at least some embodiments, phase 206 and 306 comprise determining at least one of a starting position and an end position of the synchronization signals within the determined time slots.

In an example in accordance with at least some embodiments, phase 310 comprises indicating a part of a synchronization signal block index via a physical broadcast channel of the synchronization signal block. In an example the indicating may comprise transmitting an indication of a part of a synchronization signal block index via a physical broadcast channel of the synchronization signal block. The index provides determining the synchronization signal numerology for more than one beam.

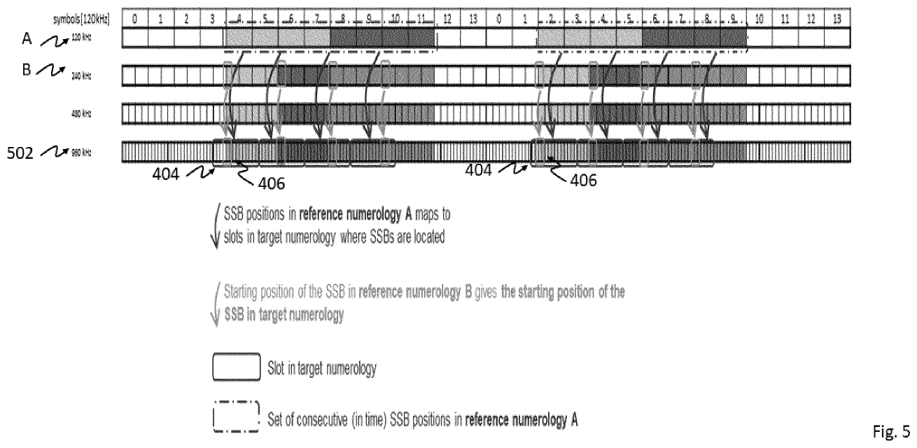

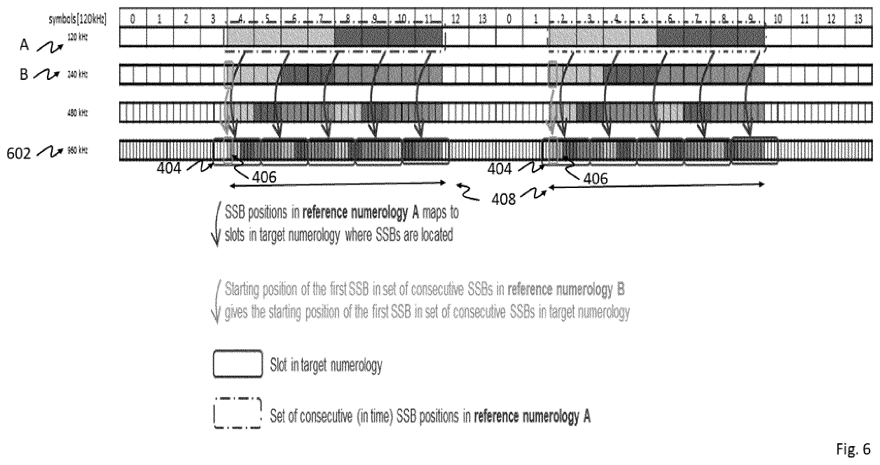

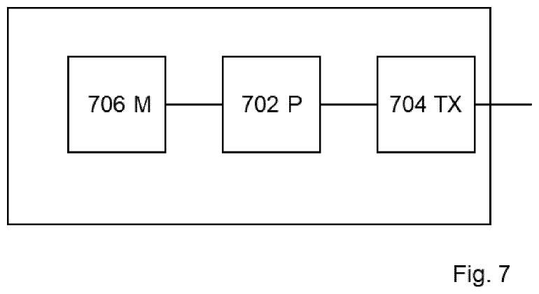

FIGS. 4 to 6 illustrate examples of determining time-domain positions of synchronization signals in accordance with at least some embodiments of the present invention. In the following the example of FIG. 4 is referred to as Option 1, the example of FIG. 5 is referred to as Option 2 and the example of FIG. 6 is referred to Option 3. The synchronization signals may be SSBs. In FIGS. 4 to 6, the reference numerologies may be two of the existing numerologies defined for a synchronization signal block (SSB) in Release 15. A target numerology 402, 502, 602 may be determined on the basis of the reference numerologies. The target numerology may correspond to a subcarrier spacing lower, greater or equal to the reference numerology. Based on the existing numerologies of the Release 15 specifications, examples of the target numerologies comprise e.g. 60 kHz, 240 kHz, 480 kHz or 960 kHz numerologies defined in Table 4.2-1. The SSB of the target numerology inherits one or more predefined properties from the reference numerologies. A reference numerology “A”, in this example the 120 kHz numerology, may be used to determine the time slots 404 in the target numerology 402 where the SSBs of target numerology are located. In other words, SSB positions in reference numerology A are used to define the time slots in the target numerology where the SSBs are located.

A reference numerology “B”, in this example the 240 kHz numerology, may be used to determine the SSB position 406 within the time slot determined on the basis of the reference numerology A. In accordance with FIG. 4, a starting position of the SSB in time is the same as with the reference numerology B and SSB structure is kept the same with the reference numerology B. In an example, the reference numerology B defines starting and ending symbols of the SSBs in target numerology 402.

In accordance with FIG. 5, a starting position of the SSB in time is the same as with the reference numerology B and the SSB structure is extended in time to make the SSB duration in absolute time the same between target numerology 502 and reference numerology B. In an example, the reference numerology B defines starting and ending symbols of the SSBs in target numerology.

In accordance with FIG. 6, a starting position of the first SSB is determined by the reference numerology B. For example, the reference numerology defines a starting position of a first SSB of consecutive SSBs 608.

With reference to FIG. 2 and FIGS. 4 to 6, in an example phase 202 comprises a UE performing an initial search for an SSB in candidate positions for the SSB. The candidate positions may be determined at the UE on the basis of one information of one or more target numerologies and one or more options for determining positions of the SSBs provided to the UE beforehand. In an example, the UE may be provided with:
a target numerology 960 kHz and one of Option 1 and Option 2 for determining SSB positions
target numerology 240 kHz and Option 1 for determining SSB positions, or target numerology 960 kHz and Option 2 for determining SSB positions.

It should be appreciated that the above priori information may be frequency band dependent, e.g. defined in specifications per frequency band or given to the UE over a wireless link. The wireless link may be on a different carrier frequency than the carrier frequency for communications of the SSB. The specifications may define different scenarios that each may have information of one or more target numerologies and one or more options for determining positions of the SSBs. For example, the scenario to be applied by the UE may depend e.g. on the frequency band and regulatory information of the considered band, for example if the frequency band is a licensed frequency band or an unlicensed frequency band and information about the maximum EIRP on the frequency band.

Now referring to the examples of FIGS. 4 to 6 and phases of the method of FIG. 2, in an example in accordance with at least some embodiments, phase 202 comprises receiving a synchronization signal index for determining a set of synchronization signals and determining positions of the synchronization signals based on the synchronization signal index. In an example, the synchronization signal index may be received in a PBCH of SSB. The SSB may be received e.g. in an initial search for an SSB in candidate positions for the SSB. It should be appreciated that phase 302 of FIG. 3 may comprise transmitting a synchronization signal index for determining a set of synchronization signals and determining positions of the synchronization signals based on the synchronization signal index. In an example, a part of a synchronization signal block index is transmitted via a physical broadcast channel of the synchronization signal block. The synchronization signal index provides determining the synchronization signal numerology for more than one beam. The synchronization signal numerology may support more than 64 positions of the synchronization signal in a frame structure of the communications system. The synchronization signal index may be defined by additional bits that may have been added the PBCH of SSB as follows for Option 2 and Option 3 for determining positions of SSB:

Option 2:
a. One additional bit is added into PBCH payload (physical layer bits) to indicate whether detected SSB belongs to first 64 SSBs or to SSBs 65-128
   i. SSB index=n×64+SSB index (3 Most Significant Bits (MSBs) in PBCH and 3 Least Significant Bits (LSBs) in PBCH Demodulation Reference Signal (DMRS) and physical layer payload) where n={0, 1}

Option 3:
a. Target numerology 240 kHz
   i. One additional bit (field named as n) is added into PBCH payload (physical layer bits) to indicate whether detected SSB belongs to first 64 SSBs or to SSBs 65-128
      1. SSB index=n×64+SSB index (0, . . . , 63: 3 MSBs in PBCH and 3 LSBs in PBCH DMRS) where n={0, 1}
b. Target numerology 480 kHz
   i. Two additional bits (field named as n) is added into PBCH payload (physical layer bits) to indicate whether detected SSB belongs to first 64 SSBs or to SSBs 65-128
      1. SSB index=n×64+SSB index (0, . . . , 63: 3 MSBs in PBCH and 3 LSBs in PBCH DMRS and physical layer payload) where n={0, 1, 2, 3}
c. Target numerology 960 kHz
   i. Two additional bits (field named as n) is added into PBCH payload (physical layer bits) to indicate whether detected SSB belongs to first 64 SSBs or to SSBs 65-128
      1. SSB index=n×64+SSB index (0, . . . , 63: 3 MSBs in PBCH and 3 LSBs in PBCH DMRS and physical layer payload) where n={0, 1, 2, 3}

In an example in accordance with at least some embodiments, phase 206 and 306 comprise determining synchronization signal numerologies for more than one beam and determining positions of the synchronization signals of each beam on the basis of the at least two reference numerologies. In an example the reference numerologies may be the supported transmission numerologies by Release 15 specifications defined in Table 4.2-1. The synchronization signal numerologies of the beams may be the same.

In an example in accordance with at least some embodiments, the synchronization signals are SSBs and time-domain positions of the SSBs may be determined by a target numerology based on two reference numerologies. The target numerology may be a 480 kHz or 960 kHz numerology. The reference numerologies may comprise a 240 kHz and a 480 kHz numerology. One of the reference numerologies may be used to determine one or more time slots comprising the SSBs, in accordance with phase 204 and phase 304, and the other of the reference numerologies may be used to determine positions of the SSBs within the determined time slots, in accordance with phase 206 and phase 306.

FIG. 8 illustrates an example of an apparatus in accordance with at least some embodiments of the present invention. The apparatus may be a radio device, for example a radio access node or a user radio device. The apparatus may perform one or more functionalities according to examples described herein.

The apparatus comprises a processor (P) 802 and a transceiver (TX) 804. The processor is operatively connected to the transceiver for controlling the transceiver. The apparatus may comprise a memory (M) 806. The memory may be operatively connected to the processor. It should be appreciated that the memory may be a separate memory or included to the processor and/or the transceiver.

According to an embodiment, the processor is configured to control the transceiver to perform one or more functionalities described according to an embodiment.

A memory may be a computer readable medium that may be non-transitory. The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialized circuits such as field programmable gate arrays FPGA, application specify circuits ASIC, signal processing devices and other devices. References to computer readable program code means, computer program, computer instructions, computer code etc. should be understood to express software for a programmable processor firmware such as the programmable content of a hardware device as instructions for a processor or configured or configuration settings for a fixed function device, gate array, programmable logic device, etc.

Although the above examples describe embodiments of the invention operating within a user radio device, UE, radio access device or a gNB, it would be appreciated that the invention as described above may be implemented as a part of any apparatus comprising a circuitry in which radio frequency signals are transmitted and/or received. Thus, for example, embodiments of the invention may be implemented in a mobile phone, in a base station, in a radio station, in a user radio device, in a computer such as a desktop computer or a tablet computer comprising radio frequency communication means (e.g. wireless local area network, cellular radio, etc.).

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:

(a) hardware-only circuit implementations (such as implementations in only analogue and/or digital circuitry) and
(b) combinations of hardware circuits and software, such as (as applicable):
(i) a combination of analogue and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

### EXAMPLES

### Example 1

1. A method, comprising:
   determining a synchronization signal numerology of communications system, on the basis of at least two reference numerologies;
   determining time slots comprising synchronization signals on the basis of a first reference numerology of the at least two reference numerologies for synchronization signal numerologies;
   determining positions of the synchronization signals within the determined time slots on the basis of a second reference numerology of the at least two reference numerologies;
   determining time-domain positions of the synchronization signals according to the synchronization signal numerology at least on the basis of the determined time slots and the positions within the time slots; and
   receiving the synchronization signals at the determined time-domain positions.

### Example 2

2. The method according to example 1, comprising:
   determining starting positions for synchronization signals according to the synchronization signal numerology to be the same with starting positions according to the second reference numerology.

### Example 3

3. The method according to example 1 or 2 comprising:
   determining a duration, in absolute time or in a number of symbols, of the synchronization signal to be the same as for synchronization signals in accordance with the second reference numerology.

### Example 4

4. The method according to any of examples 1 to 3, comprising:
   determining at least one of a starting position and an end position of the synchronization signals within the determined time slots.

### Example 5

5. The method according to any of examples 1 to 4, comprising:
   receiving a synchronization signal index for determining a set of synchronization signals;
   determining time-domain positions of the synchronization signals based on the synchronization signal index.

### Example 6

6. The method according to any of examples 1 to 5, comprising:
   determining the synchronization signal numerology for more than one beam; and
   determining time-domain positions of the synchronization signals of each beam on the basis of the at least two reference numerologies.

### Example 7

7. The method according to any of examples 1 to 6, wherein the synchronization signal numerology supports more than 64 time-domain positions of the synchronization signal in a frame structure of the communications system.
8. The method according to any of examples 1 to 7, comprising: receiving an indication of a part of a synchronization signal block index via a physical broadcast channel of the synchronization signal block.

### Example 9

9. An apparatus, comprising:
   means for determining a synchronization signal numerology of communications system, on the basis of at least two reference numerologies;
   means for determining time slots comprising synchronization signals on the basis of a first reference numerology of the at least two reference numerologies for synchronization signal numerologies;
   means for determining positions of the synchronization signals within the determined time slots on the basis of a second reference numerology of the at least two reference numerologies;
   means for determining time-domain positions of the synchronization signals according to the synchronization signal numerology at least on the basis of the determined time slots and the positions within the time slots; and
   means for receiving the synchronization signals at the determined time-domain positions.

### Example 10

10. The apparatus according to claim 9, comprising:
   means for determining starting positions for synchronization signals according to the synchronization signal numerology to be the same with starting positions according to the second reference numerology.

### Example 11

11. The apparatus according to any of examples 9 or 10 comprising:
   means for determining a duration, in absolute time or in a number of symbols, of the synchronization signal to be the same as for synchronization signals in accordance with the second reference numerology.

### Example 12

12. The apparatus according to any of examples 9 to 11, comprising:
   means for determining at least one of a starting position and an end position of the synchronization signals within the determined time slots.

### Example 13

13. The apparatus according to any of examples 9 to 12, comprising:
   means for receiving a synchronization signal index for determining a set of synchronization signals;
   means for determining time-domain positions of the synchronization signals based on the synchronization signal index.

### Example 14

14. The apparatus according to any of examples 9 to 13, comprising:
   means for determining synchronization signal numerologies for more than one beam; and
   means for determining time-domain positions of the synchronization signals of each beam on the basis of the at least two reference numerologies.

### Example 15

15. The apparatus according to any of examples 9 to 14, wherein the synchronization signal numerology supports more than 64 time-domain positions of the synchronization signal in a frame structure of the communications system.
16. The apparatus according to any of examples 9 to 15, comprising: means for receiving an indication of a part of a synchronization signal block index via a physical broadcast channel of the synchronization signal block.

### Example 17

17. A method, comprising:
   determining a synchronization signal numerology of communications system, on the basis of at least two reference numerologies;
   determining time slots comprising synchronization signals on the basis of a first reference numerology of the at least two reference numerologies for synchronization signal numerologies;
   determining positions of the synchronization signals within the determined time slots on the basis of a second reference numerology of the at least two reference numerologies;
   determining time-domain positions of the synchronization signals according to the synchronization signal numerology at least on the basis of the determined time slots and the positions within the time slots; and
   transmitting the synchronization signals at the determined time-domain positions.

### Example 18

18. The method according to claim 17, comprising:
   determining starting positions for synchronization signals according to the synchronization signal numerology to be the same with starting positions according to the second reference numerology.

### Example 19

19. The method according to claim 17 or 18 comprising:
   determining a duration, in absolute time or in a number of symbols, of the synchronization signal to be the same as for synchronization signals in accordance with the second reference numerology.

### Example 20

20. The method according to any of examples 17 to 19, comprising:
   determining at least one of a starting position and an end position of the synchronization signals within the determined time slots.

### Example 21

21. The method according to any of examples 17 to 20, comprising:
   transmitting a synchronization signal index for determining a set of synchronization signals;
   determining time-domain positions of the synchronization signals based on the synchronization signal index.

### Example 22

22. The method according to any of examples 17 to 21, comprising:
   determining synchronization signal numerologies for more than one beam; and
   determining time-domain positions of the synchronization signals of each beam on the basis of the at least two reference numerologies.

### Example 23

23. The method according to any of examples 17 to 22, wherein the synchronization signal numerology supports more than 64 time-domain positions of the synchronization signal in a frame structure of the communications system.
24. The method according to any of claims 17 to 23, comprising: indicating a part of a synchronization signal block index via a physical broadcast channel of the synchronization signal block.

### Example 25

25. An apparatus, comprising:
   means for determining a synchronization signal numerology of communications system, on the basis of at least two reference numerologies;
   means for determining time slots comprising synchronization signals on the basis of a first reference numerology of the at least two reference numerologies for synchronization signal numerologies;
   means for determining positions of the synchronization signals within the determined time slots on the basis of a second reference numerology of the at least two reference numerologies;
   means for determining time-domain positions of the synchronization signals according to the synchronization signal numerology at least on the basis of the determined time slots and the positions within the time slots; and
   means for receiving the synchronization signals at the determined time-domain positions.

### Example 26

26. The apparatus according to claim 25, comprising:
   means for determining starting positions for synchronization signals according to the synchronization signal numerology to be the same with starting positions according to the second reference numerology.

### Example 27

27. The apparatus according to any of examples 25 or 26 comprising:
   means for determining a duration, in absolute time or in a number of symbols, of the synchronization signal to be the same as for synchronization signals in accordance with the second reference numerology.

### Example 28

28. The apparatus according to any of examples 25 to 27, comprising:
   means for determining at least one of a starting position and an end position of the synchronization signals within the determined time slots.

### Example 29

29. The apparatus according to any of examples 25 to 28, comprising:
   means for receiving a synchronization signal index for determining a set of synchronization signals;
   means for determining time-domain positions of the synchronization signals based on the synchronization signal index.

### Example 30

30. The apparatus according to any of examples 25 to 29, comprising:
   means for determining synchronization signal numerologies for more than one beam; and
   means for determining time-domain positions of the synchronization signals of each beam on the basis of the at least two reference numerologies.

### Example 31

31. The apparatus according to any of examples 25 to 30, wherein the synchronization signal numerology supports more than 64 time-domain positions of the synchronization signal in a frame structure of the communications system.
32. The apparatus according to any of claims 25 to 32, comprising: means for indicating a part of a synchronization signal block index via a physical broadcast channel of the synchronization signal block.

### Example 33

33. An apparatus comprising at least one processor; and at least one memory including computer program code; the at least one memory and the computer program code configured to, with the at least one processor, to cause the apparatus to:
   determine a synchronization signal numerology of communications system, on the basis of at least two reference numerologies;
   determine time slots comprising synchronization signals on the basis of a first reference numerology of the at least two reference numerologies for synchronization signal numerologies;
   determine positions of the synchronization signals within the determined time slots on the basis of a second reference numerology of the at least two reference numerologies;
   determine time-domain positions of the synchronization signals according to the synchronization signal numerology at least on the basis of the determined time slots and the positions within the time slots; and
   receive the synchronization signals at the determined time-domain positions.

### Example 34

34. An apparatus comprising at least one processor; and at least one memory including computer program code; the at least one memory and the computer program code configured to, with the at least one processor, to cause the apparatus to:
   determine a synchronization signal numerology of communications system, on the basis of at least two reference numerologies;
   determine time slots comprising synchronization signals on the basis of a first reference numerology of the at least two reference numerologies for synchronization signal numerologies;
   determine positions of the synchronization signals within the determined time slots on the basis of a second reference numerology of the at least two reference numerologies;
   determine time-domain positions of the synchronization signals according to the synchronization signal numerology at least on the basis of the determined time slots and the positions within the time slots; and
   transmit the synchronization signals at the determined time-domain positions.

### Example 35

35. A computer program comprising computer readable program code means adapted to perform at least the following:
   determining a synchronization signal numerology of communications system, on the basis of at least two reference numerologies;
   determining time slots comprising synchronization signals on the basis of a first reference numerology of the at least two reference numerologies for synchronization signal numerologies;
   determining positions of the synchronization signals within the determined time slots on the basis of a second reference numerology of the at least two reference numerologies;
   determining time-domain positions of the synchronization signals according to the synchronization signal numerology at least on the basis of the determined time slots and the positions within the time slots; and
   receiving the synchronization signals at the determined time-domain positions.

### Example 36

36. A computer program comprising computer readable program code means adapted to perform at least the following:
   determining a synchronization signal numerology of communications system, on the basis of at least two reference numerologies;
   determining time slots comprising synchronization signals on the basis of a first reference numerology of the at least two reference numerologies for synchronization signal numerologies;
   determining positions of the synchronization signals within the determined time slots on the basis of a second reference numerology of the at least two reference numerologies;
   determining time-domain positions of the synchronization signals according to the synchronization signal numerology at least on the basis of the determined time slots and the positions within the time slots; and
   transmitting the synchronization signals at the determined time-domain positions.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1. A method, comprising:
determining a synchronization signal numerology of communications system, on the basis of at least two reference numerologies;
determining time occasions comprising synchronization signals on the basis of a first reference numerology of the at least two reference numerologies for synchronization signal numerologies;
determining positions of the synchronization signals within the determined time occasions on the basis of a second reference numerology of the at least two reference numerologies;
determining time-domain positions of the synchronization signals according to the synchronization signal numerology at least on the basis of the determined time occasions and the positions within the time occasions; and
receiving the synchronization signals at the determined time-domain positions.

2. The method according to claim 1, comprising:
determining starting positions for synchronization signals according to the synchronization signal numerology to be the same with starting positions according to the second reference numerology.

3. The method according to claim 1 comprising:
determining a duration, in absolute time or in a number of symbols, of the synchronization signal to be the same as for synchronization signals in accordance with the second reference numerology.

4. The method according to claim 1, comprising:
determining at least one of a starting position or an end position of the synchronization signals within the determined time occasions.

5. The method according to claim 1, comprising:
receiving a synchronization signal index for determining a set of synchronization signals;
determining time-domain positions of the synchronization signals based on the synchronization signal index.

6. The method according to claim 1, comprising:
determining the synchronization signal numerology for more than one beam; and
determining time-domain positions of the synchronization signals of each beam on the basis of the at least two reference numerologies.

7. The method according to claim 1, wherein the synchronization signal numerology supports more than 64 time-domain positions of the synchronization signal in a frame structure of the communications system.

8. (canceled)

9. An apparatus, comprising:
at least one processor; and
at least one non-transitory memory including computer program code,
the at least one memory and the computer program code configured to, with the at least one processor, cause the apparatus to perform:
determining a synchronization signal numerology of communications system, on the basis of at least two reference numerologies;
determining time occasions comprising synchronization signals on the basis of a first reference numerology of the at least two reference numerologies for synchronization signal numerologies;
determining positions of the synchronization signals within the determined time occasions on the basis of a second reference numerology of the at least two reference numerologies;
determining time-domain positions of the synchronization signals according to the synchronization signal numerology at least on the basis of the determined time occasions and the positions within the time occasions; and
receiving the synchronization signals at the determined time-domain positions.

10-16. (canceled)

17. A method, comprising:
determining a synchronization signal numerology of communications system, on the basis of at least two reference numerologies;
determining time occasions comprising synchronization signals on the basis of a first reference numerology of the at least two reference numerologies for synchronization signal numerologies;
determining positions of the synchronization signals within the determined time occasions on the basis of a second reference numerology of the at least two reference numerologies;
determining time-domain positions of the synchronization signals according to the synchronization signal numerology at least on the basis of the determined time occasions and the positions within the time occasions; and transmitting the synchronization signals at the determined time-domain positions.

18. The method according to claim 17, comprising:
determining starting positions for synchronization signals according to the synchronization signal numerology to be the same with starting positions according to the second reference numerology.

19. The method according to claim 17 comprising:
determining a duration, in absolute time or in a number of symbols, of the synchronization signal to be the same as for synchronization signals in accordance with the second reference numerology.

20. The method according to claim 17, comprising:
determining at least one of a starting position or an end position of the synchronization signals within the determined time occasions.

21. The method according to claim 17, comprising:
transmitting a synchronization signal index for determining a set of synchronization signals;
determining time-domain positions of the synchronization signals based on the synchronization signal index.

22. The method according to claim 17, comprising:
determining synchronization signal numerologies for more than one beam; and
determining time-domain positions of the synchronization signals of each beam on the basis of the at least two reference numerologies.

23. The method according to claim 17, wherein the synchronization signal numerology supports more than 64 time-domain positions of the synchronization signal in a frame structure of the communications system.

24. (canceled)

25. An apparatus, comprising:
at least one processor; and
at least one non-transitory memory including computer program code,
the at least one memory and the computer program code configured to, with the at least one processor, cause the apparatus to perform:
determining a synchronization signal numerology of communications system, on the basis of at least two reference numerologies;
determining time occasions comprising synchronization signals on the basis of a first reference numerology of the at least two reference numerologies for synchronization signal numerologies;
determining positions of the synchronization signals within the determined time occasions on the basis of a second reference numerology of the at least two reference numerologies;
determining time-domain positions of the synchronization signals according to the synchronization signal numerology at least on the basis of the determined time occasions and the positions within the time occasions; and
receiving the synchronization signals at the determined time-domain positions.

26-36. (canceled)
